(19) United States
(12) Patent Application Publication
(10) Pub. No.: US 2004/0074680 A1
(43) Pub. Date: Apr. 22, 2004

(54) Wheelchair with castors

(76) Inventor: Thomas Brendel, Sinsheim (DE)

Correspondence Address: McGuireWoods LLP, Suite 1800, 1750 Tysons Boulevard, Tysons Corner, McLean, VA, 22102-4215, US

(21) Appl. No.: 10/647,652

(22) Filed: Aug. 26, 2003

(30) Foreign Application Priority Data
Aug. 29, 2002 (DE) 102 39 717.1

(51) Int. Cl. B60K 1/00

(52) U.S. Cl. 180/65.1

(57) ABSTRACT

A wheelchair having two driven wheels (40) and at least one castor (1) which is mounted in a rotatable manner in a fork (2) which can be pivoted about a vertical axis (H), the fork (2) being connected to a steering linkage (3, 3′, 30), is distinguished in that the connection between the fork (2) and the steering linkage (3, 3′, 30) is releasable.

The invention relates to a wheelchair having two driven wheels and at least one castor which is mounted in a rotatable manner in a fork which can be pivoted about a vertical axis, the fork being connected to a steering linkage.

Such a wheelchair is known, for example, from EP 0 324 101 A2. In the case of such wheelchairs, the two drive wheels are driven by an electric motor.

Electric wheelchairs are generally designed for use outdoors and thus for covering relatively large distances on roads and paths. In order to increase the tracking stability, the steering system is configured as a positive steering system. Rather than one or two central castors being provided, it is usually the case that in each case one castor is mounted in a fork in each case on both sides of the wheelchair. The positive steering usually takes place in that an electric servomotor keeps the forks of the castors on track over the steering angle set by the user. Use of the steering linkage, via which the forks are coupled to one another, limits the possible steering angle, with the result that the smallest turning circle is a few meters. Such wheelchairs are thus only suitable to a limited extent, if at all, indoors or in confined spaces.

Wheelchairs which are to be used in confined spaces usually have freely steered castors. These freely steered castors are mounted in forks which can be rotated freely about their vertical axis. Each drive wheel is driven by a dedicated electric motor. The direction of travel predetermined by the user is maintained not via the castors, but by way of different activation of the drive wheels. Depending on the direction of travel, the castors bring themselves on track by way of a correspondingly predetermined castor action. On account of the forks being able to rotate freely independently of one another, it is possible to realize a small turning circle (the wheelchair can be rotated more or less on the spot). However, this advantage comes at the expense of considerably poorer tracking stability, with the result that such wheelchairs are not suitable for use over long distances outdoors.

Taking this problem as the departure point, the intention is to improve an electrically driven wheelchair to the extent that it has both a high level of tracking stability and a small turning circle, with the result that it is suitable both for long distances outdoors and for use in confined spaces.

In order to solve the problem, a wheelchair of the generic type is distinguished in that the connection between the fork and the steering linkage is releasable.

This configuration makes it possible to change over between positive steering and free steering. For the long distances and a high level of tracking stability, the at least one fork is, or two forks spaced apart by a track width are, connected to the steering linkage, with the result that it is only possible for the forks to be pivoted about the vertical axis. In order to reduce the turning circle, the forks are separated from the steering linkage. The direction of travel of the wheelchair is then predetermined by way of individual activation of the drive wheels and the castors can rotate freely through 360°, with the result that the wheelchair can be rotated more or less on the spot.

The forks are preferably mounted in a rotatable manner in a bushing which is fixed to the frame of the wheelchair.

The operations of blocking the forks in relation to the steering linkage and separating them therefrom preferably take place mechanically, the blockage taking place in the straight-ahead position.

The forks are mounted in the bushing via a fork pin. The blockage of the forks preferably takes place by means of a bolt which can be pushed, transversely to the vertical axis, into a recess provided in the fork pin. The recess may be designed as a through-passage bore.

It is advantageous, in particular, if the bolt is subjected to loading by a compression spring, with the result that secure latching of the bolt in the recess in the fork pin is possible. The recess in the fork pin is circumferentially configured such that the bolt latches of its own accord therein when it coincides with the recess.

The bolt can be displaced via a pivot lever, which is manually actuated by the user or moved in an electromotive manner by the control means.

It is advantageous if the pivot lever is mounted on a spindle fastened in the bushing.

The exemplary embodiments of the invention are explained in more detail hereinbelow with the aid of a drawing, in which:

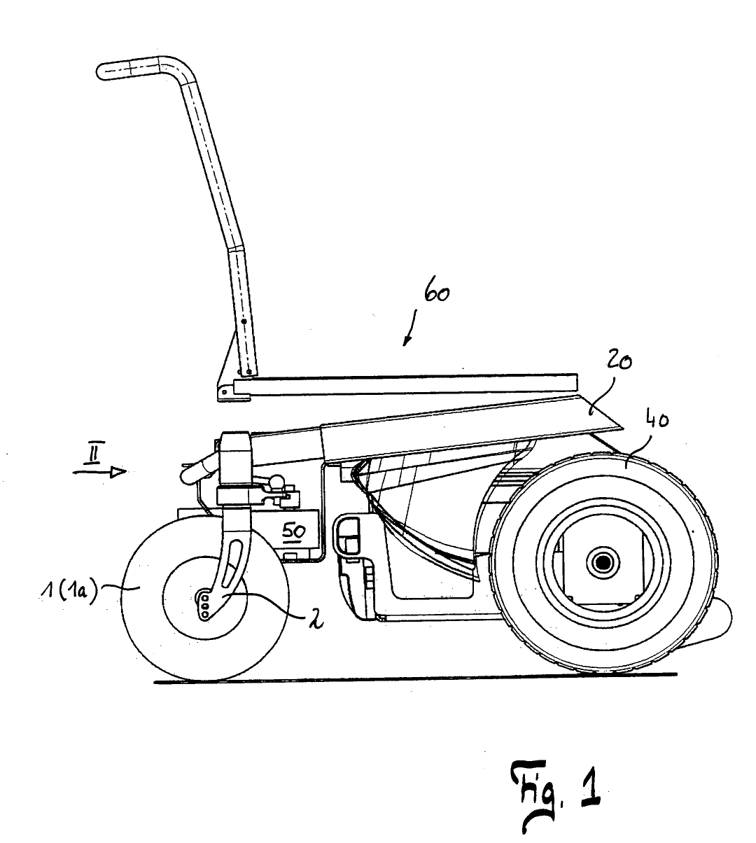

FIG. 1 shows the schematic side view of a wheelchair;

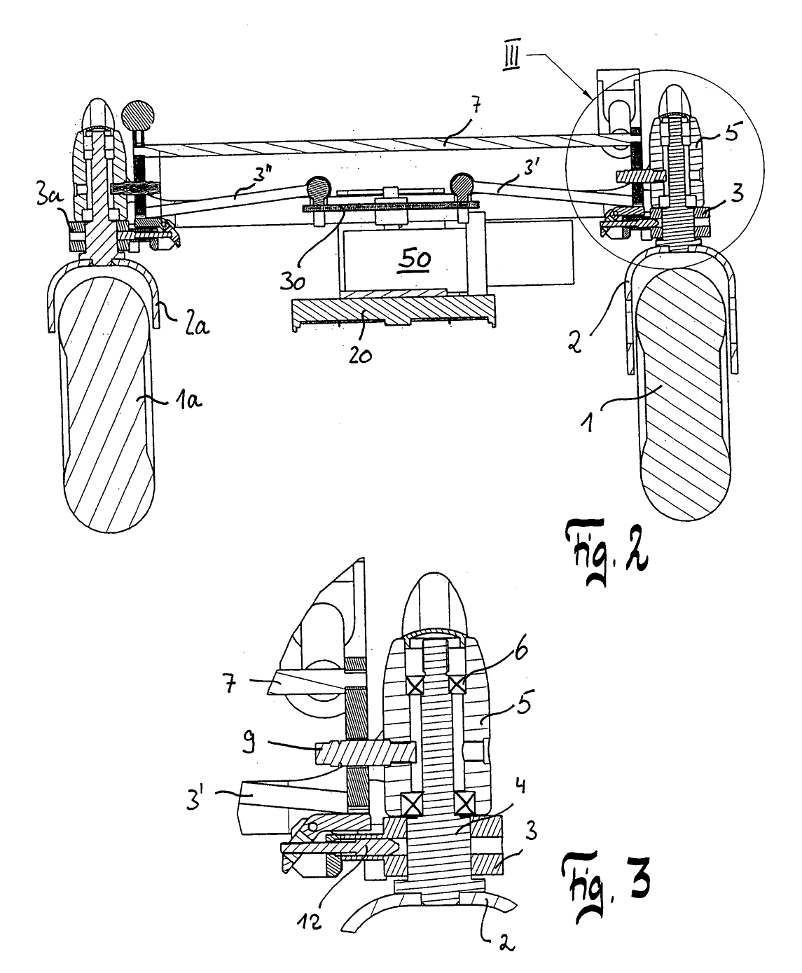

FIG. 2 shows a partial illustration corresponding to the viewing arrow II according to FIG. 1;

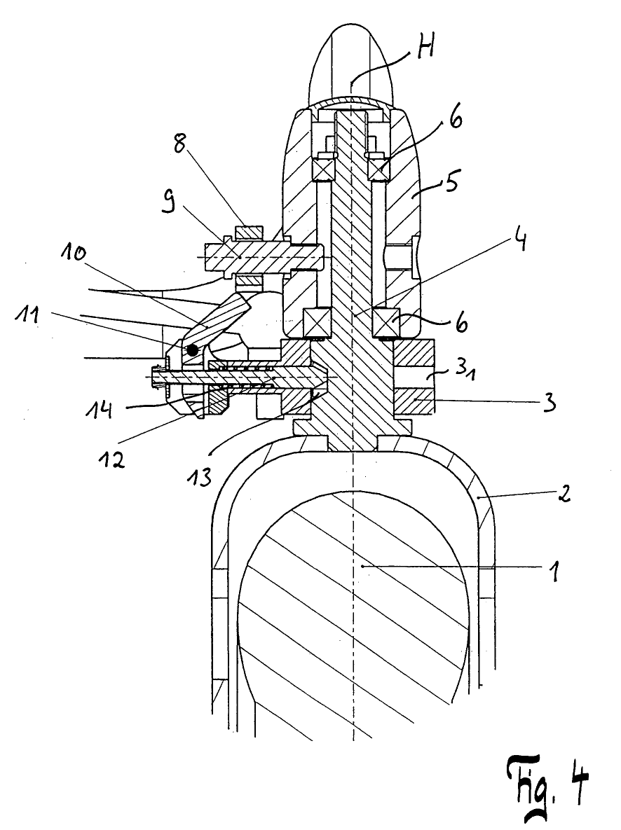

FIG. 3 shows the detail corresponding to viewing arrow III according to FIG. 2;

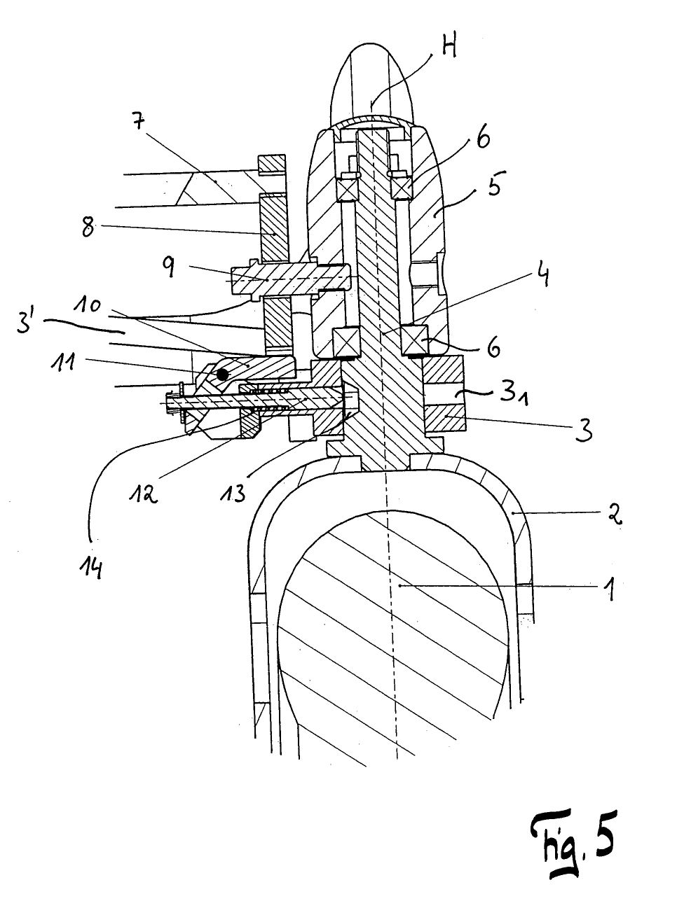

FIG. 4 shows an enlarged partial illustration from FIG. 2, in the positively steered mode;

FIG. 5 shows the view according to FIG. 4 in the freely steered mode;

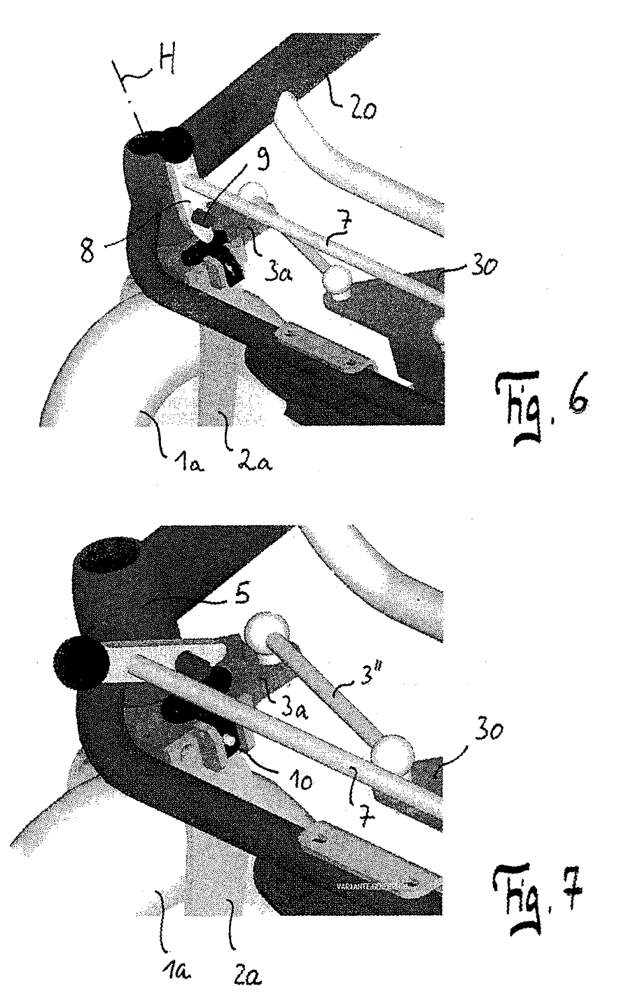

FIG. 6 shows a perspective partial illustration of the steering system in the unlocked state of the forks;

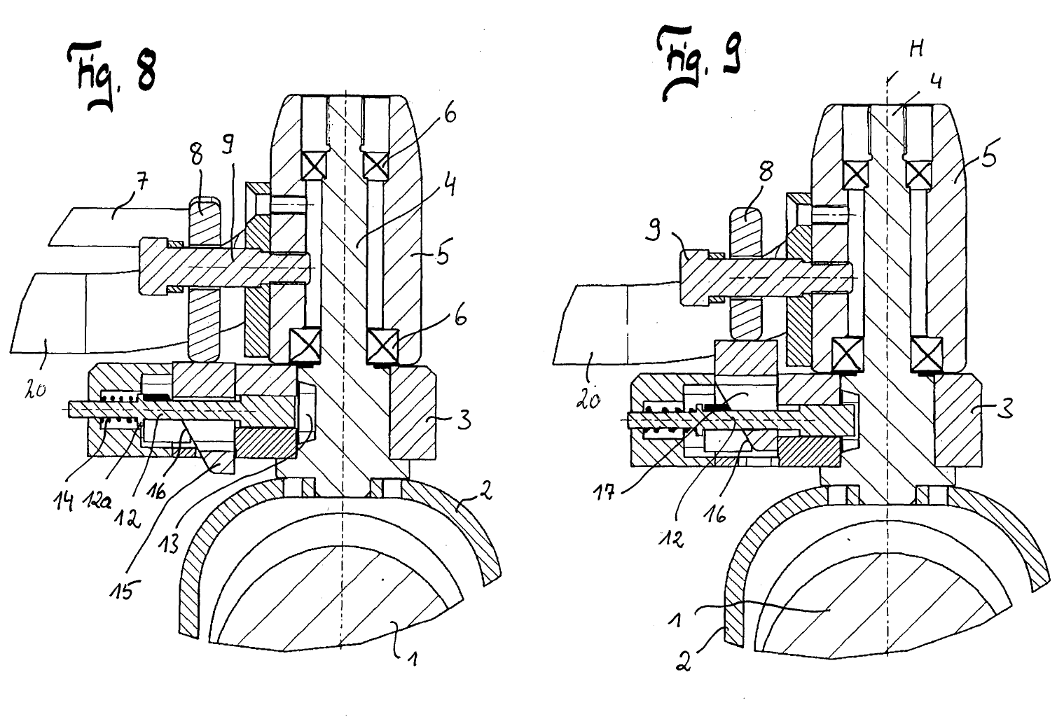

FIG. 7 shows a perspective partial illustration of the steering system in the locked position of the forks;

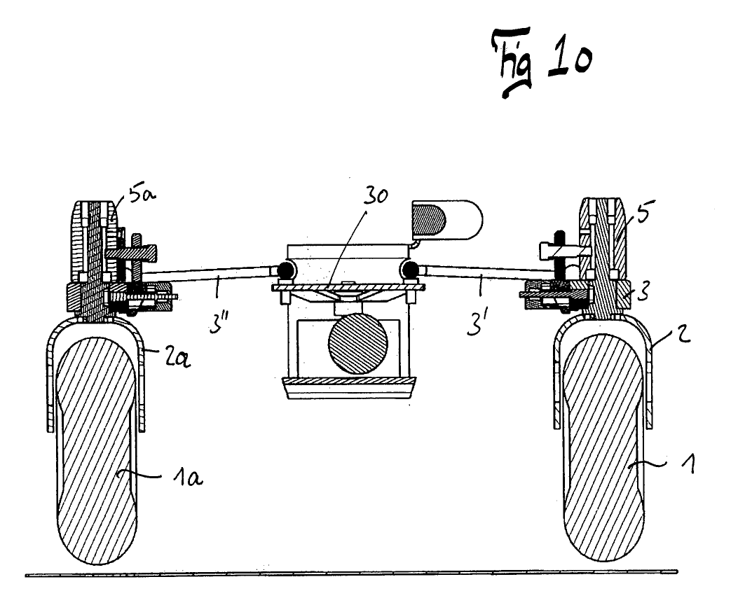

FIG. 8 shows a partial illustration, corresponding to FIG. 5, of a further exemplary embodiment;

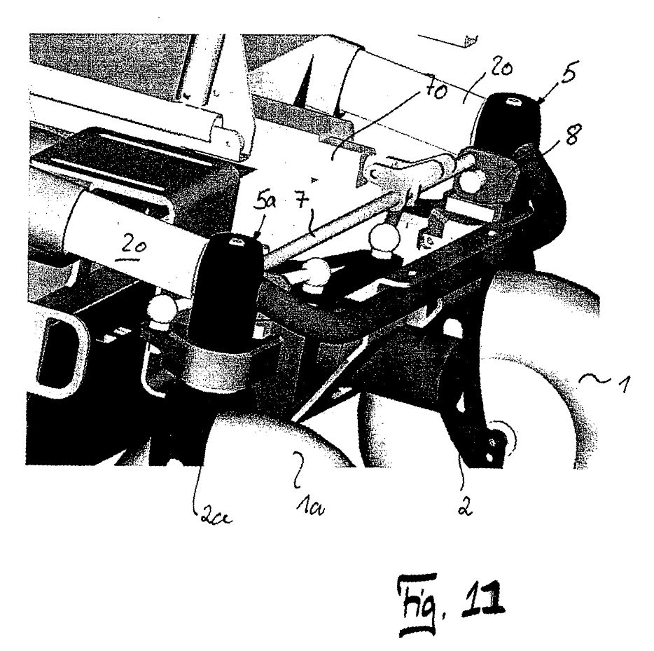

FIG. 9 shows a partial illustration, corresponding to FIG. 4, of the exemplary embodiment according to FIG. 8;

FIG. 10 shows a partial illustration corresponding to the viewing arrow II according to FIG. 1 in the case of the further exemplary embodiment;

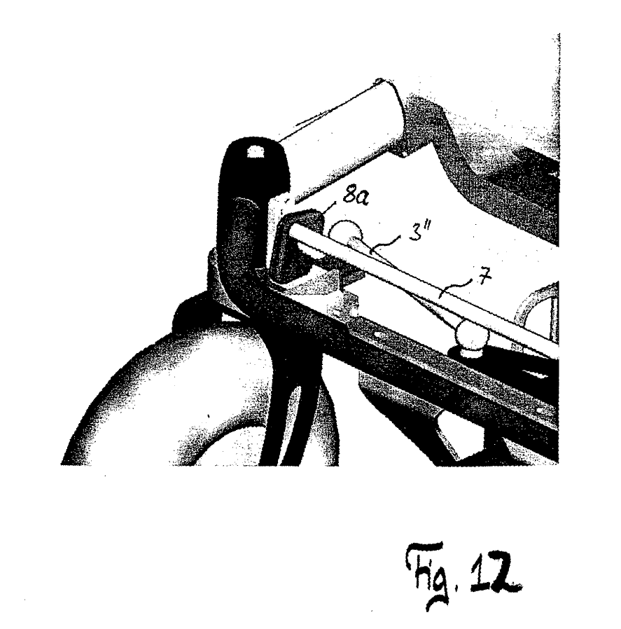

FIG. 11 shows a partial illustration, in perspective, of the further exemplary embodiment;

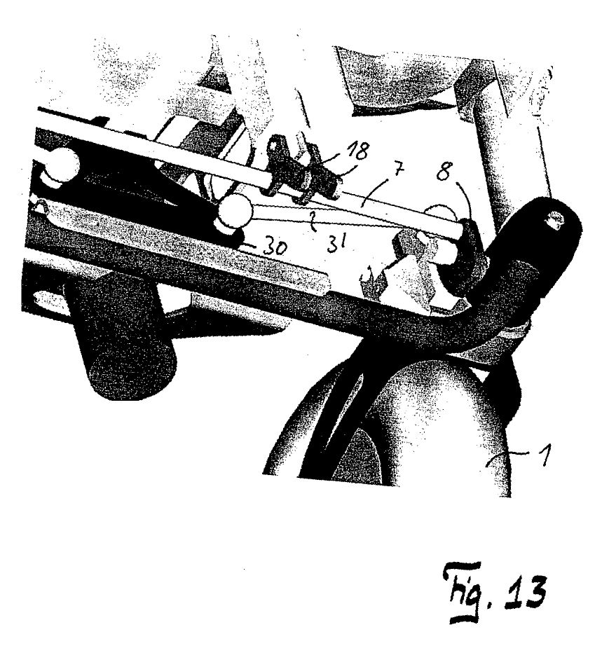

FIG. 12 shows the partial illustration, in perspective, of the steering system of the further exemplary embodiment in the locked state;

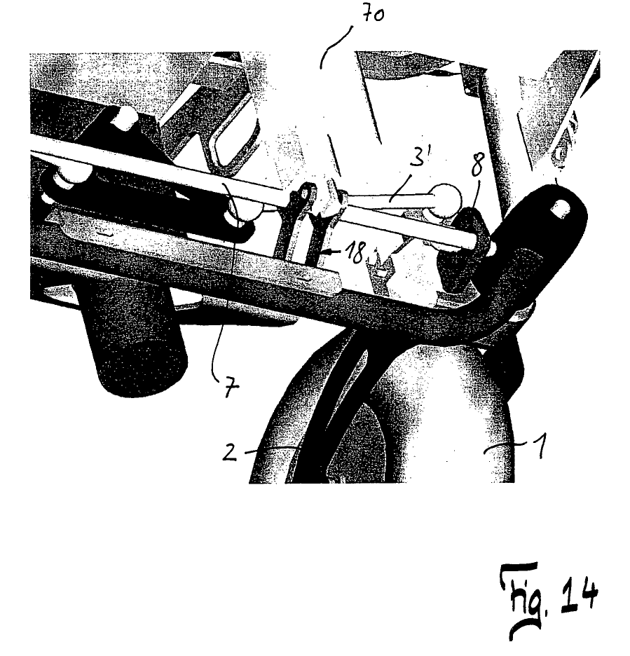

FIG. 13 shows a perspective illustration of the locking mechanism according to the exemplary embodiment in the locked position; and

FIG. 14 shows the illustration according to FIG. 13 in the unlocked position.

The electric wheelchair essentially comprises the frame 20, which inter alia also accommodates the seat system 60, and further comprises the drive wheels 40, which can be driven independently via in each case one drive motor—not illustrated specifically here—and the non-driven castors 1, 1a. The castors 1, 1a are mounted in a rotatable manner in forks 2, 2a. The steering system of the wheelchair is of symmetrical construction, so that the invention will be explained further in relation to one side (on the right in FIG. 2).

The fork 2 has an upwardly projecting fork pin 4 which is mounted in a freely rotatable manner, via rolling-contact bearings 6, in a bushing 5 connected to the frame 20.

The forks 2, 2a are connected to one another via the steering linkage 3, 3′, 30, 3″, 3a. The outer ends 3, 3a of the steering linkage are provided with a horizontally running through-passage bore 31 and a vertical bore (not designated specifically) which accommodates the fork pin 4. The fork pin 4 has a recess 13 running coaxially in relation to the through-passage bore 3₁.

A bolt 12 is latched in the recess 13 in the positively steered state, said bolt preventing the fork 2 from being able to rotate in the bushing 5. The bolt 12 is subjected to loading by a compression spring 14 and is connected to an actuating lever 10, which is mounted in a pivotable manner on a spindle 11 and, in turn, interacts with a pivot lever 8, which can be pivoted in a vertical plane on a spindle 9 fastened in the bushing 5. The pivoting movement of the pivot lever 8 is initiated by the connecting linkage 7 being pivoted correspondingly. For this purpose, the front end of the pivot lever 8 has a rounded protuberance (see FIGS. 6 and 7).

In the positively steered mode (blocked fork pin 4), the direction of travel predetermined by the user is set via the steering servo 50 by the latter rotating the pivotably mounted plate 30, which bears the links 3′, 3″ at its outer ends. The pivoting angle of the forks 2, 2a, and thus the steering angle of the wheels 1, 1a, is determined by the defined pivoting-angle range of the plate 30. In this mode, the mechanical coupling of the forks 2, 2a achieves a high level of tracking stability for the wheelchair, which makes it possible for the wheelchair to be controlled to good effect over long distances outdoors.

In order to make a small turning circle of the wheelchair possible when the latter is used, for example, in confined spaces, the forks 2, 2a can be unlocked by the bolt 12 being drawn out of the recess 13 in the fork pin 4 counter to the force of the compression spring 14, by means of the lever 10. The fork pin 4 can then be rotated through 360° in relation to the ends 3, 3a of the steering linkage. The connection between the forks 2, 2a is thus eliminated. Rather than being predetermined via the servomotor 50, the direction of travel of the wheelchair can now only be predetermined by the drive wheels 40 being driven differently by way of the drive motors assigned to them. Corresponding to the castor action of the forks 2, 2a, the wheel position of the castors 1, 1a is then established in accordance with the direction of travel predetermined by the user. If the drive wheels are driven in opposite directions, the castors 1, 1a position themselves transversely to the straight-ahead position, with the result that it is possible for the wheelchair to rotate on the spot.

The activation of the motors of the drive wheels and of the servomotor 50 (steering servo) is achieved by means of suitable software which changes over the steering movement predetermined by the user in accordance with the desired direction of travel. The locking device may be actuated in an electromotive manner or by hand.

The recess 13 in the fork pin 4 is countersunk around the circumference and thus configured such that the bolt 12, which is subjected to loading by a compression spring, automatically and easily engages in the recess 13 when it coincides coaxially with the through-passage bore 31 provided in the end 3 of the steering linkage.

FIGS. 8-14 show a further exemplary embodiment of the locking device. Equivalent components in the two exemplary embodiments are provided with the same designations. In the case of this exemplary embodiment, the bolt 12 is moved by a linear movement being initiated. The fork pin 4 is provided with a countersunk bore 13. The bore 12 is accommodated in the steering linkage and subjected to the action of the compression spring 14, which forces it in the direction of the recess 13. The vertically displaceable lever 15 is provided with a run-on slope 16, which interacts with a radial shoulder 12a on the bolt 12. The movement of the lever 15 is initiated via the pivot lever 8, which is mounted in a pivotable manner on the spindle 9. If the lever 8 is changed over, by motor or manual actuation, from its position which is shown in FIGS. 8 and 14 into the position shown in FIGS. 9 and 13, the bolt 12, via its shoulder 12a, forces the lever 15 upward along the run-on slope 16 and is pushed into the recess 13 by the compression spring 14. In order to make this horizontal movement of the bolt 12 possible, the lever 15 is provided with a correspondingly wide bore 17. As long as the bolt 12 engages in the recess 13, the positively steered mode is set. In order to change into the freely steered mode, the lever 8 is pivoted over in the other direction, with the result that it forces the lever 15 downward, as a result of which, via the run-on slope 16, the bolt is forced out of the recess 13 and the compression spring 14, at the same time, is subjected to stressing.

The two pivot levers 8 are connected to one another via the connecting linkage 7. The pivoting movement is initiated via the actuator 70, of which the piston rod interacts with a fork 18 fastened on the connecting linkage 7.

### LIST OF DESIGNATIONS

1 Castor

1a Castor

2 Fork

2a Fork

3 Outer end of the steering linkage

3a Outer end of the steering linkage

3′ Steering linkage

3″ Steering linkage

3₁ Through-passage bore

4 Fork pin

5 Bushing

5a Bushing

6 Rolling-contact bearing

7 Connecting linkage

8 Pivot lever

8a Pivot lever

9 Spindle

10 Lever

11 Pivot spindle

12 Bolt

12a Radial shoulder

13 Recess

14 Compression spring

15 Lever

16 Run-on slope

17 Bore

18 Fork

20 Framework

30 Plate

40 Drive wheel

50 Servomotor/steering servo

60 Seat system

70 Actuator

H Vertical axis

1. A wheelchair having two driven wheels (40) and at least one castor (1) which is mounted in a rotatable manner in a fork (2) which can be pivoted about a vertical axis (H), the fork (2) being connected to a steering linkage (3, 3′, 30), wherein the connection between the fork (2) and the steering linkage (3, 3′, 30) is releasable.

2. The wheelchair as claimed in claim 1, wherein two castors (1, 1a) each mounted in a fork (2, 2a) are provided, the forks (2, 2a) being connected to one another via the steering linkage (3, 3′, 30, 3″, 3a).

3. The wheelchair as claimed in claim 1 or 2, wherein the fork (2, 2a) is mounted such that it can be rotated about the vertical axis (H).

4. The wheelchair as claimed in claim 3, wherein the fork (2, 2a) is mounted such that it can be rotated through 360°.

5. The wheelchair as claimed in claim 1 or 2, wherein the forks (2, 2a) can be blocked mechanically in relation to the steering linkage (3, 3′, 30, 3″, 3a).

6. The wheelchair as claimed in claim 5, wherein the forks (2, 2a) are blocked in the straight-ahead position of the castors (1, 1a).

7. The wheelchair as claimed in one or more of the preceding claims, wherein the fork (2, 2a) is mounted, via a fork pin (4), in a bushing (5) connected to a frame (20).

8. The wheelchair as claimed in claim 5 or 6, which comprises a bolt (12) which can be pushed, transversely to the vertical axis (H), into a recess (13) provided in the fork pin (4).

9. The wheelchair as claimed in claim 8, wherein the bolt (12) can be displaced counter to the force of a compression spring (14).

10. The wheelchair as claimed in claim 8, wherein the bolt (12) can be displaced via a pivot-lever arrangement (7, 8, 10).

11. The wheelchair as claimed in claim 8, wherein the bolt (12) can be displaced via a linearly displaceable lever (15), a pivot lever (8) acting on the lever (15).

12. The wheelchair as claimed in claim 11, wherein the lever (15) is provided with a run-on slope (16), which interacts with a radial shoulder (12a) provided on the bolt (12).

13. The wheelchair as claimed in claim 11, wherein the pivot lever (8) is mounted on a spindle (9) connected to the bushing (5).

14. The wheelchair as claimed in claim 8, wherein the pivot lever (8) has a rounded protuberance at its front end.
